(19) United States
(12) Patent Application Publication
(10) Pub. No.: US 2022/0214106 A1
(43) Pub. Date: Jul. 7, 2022

(54) TREATMENT SYSTEM

(71) Applicant: TWINE SOLUTIONS LTD., Petach Tikva (IL)

(72) Inventors: Alon MOSHE, Petach Tikva (IL); Yoram ZILBERBERG, Tel Aviv (IL); Alon NAVON, Even Yehuda (IL); Yoav ROSENBACH, Ramat Gan (IL); Dror LEV, Modiin (IL); Gilad GOTESMAN, Netanya (IL)

(73) Assignee: TWINE SOLUTIONS LTD., Petach Tikva (IL)

(21) Appl. No.: 17/611,154

(22) PCT Filed: May 12, 2020
(86) PCT No.: PCT/IL2020/050509

§ 371 Date: Nov. 14, 2021

Related U.S. Application Data
(60) Provisional application No. 62/847,972, filed on May 15, 2019.

(51) Int. Cl. F26B 13/14; D06B 15/04; D06B 23/04; D06B 23/16; F26B 13/08; F26B 13/12; F26B 21/02

(52) U.S. Cl. CPC F26B 13/145; D06B 15/04; D06B 23/04; F26B 21/02; F26B 13/08; F26B 13/12; D06B 23/16

(57) ABSTRACT

Disclosed herein is a treatment unit for treating a continuously through-flowing elongate windable element, wherein said unit includes a substantially sealed enclosure for containing a gaseous environment, the enclosure having an inlet port for the continuous ingress of an elongate windable element and an outlet port for the continuous egress of treated elongate windable element, treatment apparatus located within the enclosure, for treating the elongate windable element therein, and a spatial loading system located within the enclosure, for continuous collection of the elongate windable element within the enclosure, and for conveying the elongate windable element from the inlet port to the outlet port.

### FIELD OF THE INVENTION

The present disclosure relates to the processing of continuous flow of an elongate windable element.

### BACKGROUND

The processing of elongate windable elements such as fiber or synthetic threads, as used in the textile industry, wire filaments and the like, is well known. Such processing may be required for the purpose of applying different types of treatment, such as dyeing, coating and the like, or as part of a continuous feed of such elements along a production line, for example, in the textile industry.

Examples of systems which process thread are the present Applicant's WO 2017/013651 entitled An Integrated System and Method for Treating a Thread and Using Thereof, and WO 2017/203524 entitled System, Machine and Method for Treating Threads or Parts Thereof.

### SUMMARY

In accordance with an embodiment of the present disclosure, there is provided a treatment unit for treating a continuously through-flowing elongate windable element, wherein the unit includes:

(a) a substantially sealed enclosure for containing a gaseous environment, the enclosure having an inlet port for the continuous ingress of an elongate windable element and an outlet port for the continuous egress of treated elongate windable element;

(b) treatment apparatus located within the enclosure, for treating the elongate windable element therein; and

(c) a spatial loading system located within the enclosure, for continuous collection of the elongate windable element within the enclosure, and for conveying the elongate windable element from the inlet port to the outlet port.

Additionally, treatment by the treatment apparatus causes a release of materials sought to be contained into the interior of the enclosure, and the treatment unit also includes pressure-reducing apparatus within the enclosure for preventing the exhaustion of the materials sought to be contained from within the enclosure to the exterior thereof.

Further, the pressure-reducing apparatus is operative to cause a localized reduction in pressure within the enclosure.

Additionally, the pressure-reducing apparatus includes a blower for gas circulation within the enclosure, operative to cause a reduction in pressure in an area adjacent to the inlet port.

Further, the treatment unit also includes: a suction device for removing gas from the interior of the enclosure; and

apparatus for collecting the materials sought to be contained so as to prevent their release into the atmosphere exterior to the enclosure.

Additionally, the spatial loading system is operative to convey the elongate windable element through the enclosure at a rate predetermined so as to expose it to treatment by the treatment apparatus for a predetermined dwell time.

Further, the inlet and outlet ports are spaced apart by a predetermined linear distance, the spatial loading system includes one or more loading members having a non-linear loading surface for winding the elongate windable element therealong along a non-linear loading path,

and wherein the length of the loading path is of a magnitude which is at least three times the linear distance between the inlet and outlet ports.

Additionally, the one or more loading members have a generally cylindrical surface for receiving the elongate windable element in a wound arrangement.

Further, one or more of the loading members is revolvable, and the spatial loading system also includes a drive for rotation thereof.

Additionally, the non-linear loading path is serpentine.

Further, the one or more loading members are a plurality of discrete loading members defining nodes along the serpentine loading path.

Additionally, the plurality of discrete loading members includes first and second opposing arrangements of discrete loading members, and wherein on loading, the elongate windable element becomes wound alternately about opposing loading members of each of the first and second arrangements, along the serpentine loading path.

Additionally, the inlet port is a slotted opening for the lateral insertion of a length of the elongate winding element into the treatment unit;

the first arrangement of discrete loading members is arranged in a predetermined mutual spatial relationship relative to the slotted opening so as to receive the elongate winding element therefrom;

the second arrangement of discrete loading members is movable relative to the first arrangement and the slotted opening between a first position and a second position,

wherein, in the first position, the second arrangement is disposed such that the slotted opening is disposed between the first and second arrangements,

and in the second position, the second arrangement is disposed distally from the slotted opening such that the first arrangement is positioned therebetween;

wherein each loading member of each of the first and second arrangements is spaced apart so as to enable passage of the second arrangement of discrete loading members through the first arrangement of discrete loading members when moving between the first and second positions; and

wherein when the second arrangement is located in the first position and a length of the elongate windable element is introduced laterally through the slotted opening so as to overlie the first arrangement of discrete loading members, the second arrangement is operative to translate towards the second position, through the first arrangement of discrete loading members, towards the second position, so as to engage the elongate windable element and to pull it through the members of the first arrangement along the serpentine loading path.

In accordance with a further embodiment, the spatial loading system also includes a rotational winding arm for engaging the elongate windable element so as to wind it around the one or more loading members.

Additionally, the loading path is helical, and the one or more loading members are configured to receive the elongate windable element thereabout in a helical arrangement, of which adjacent coils are non-touching.

Further, the exterior of each of the one or more loading members is contoured so as to define the helical loading path.

Additionally, the spatial loading system also includes:

a drive;

a transmission for transmitting a rotational motion from the drive to the rotational winding arm; and

a controller for controlling the operation of the drive, the controller operative to adjust the drive in a manner so as to adjust the dynamic conditions at which the spatial loading system collects and conveys the elongate windable element from the inlet port to the outlet port of the enclosure.

Further, the controller is operable to normally operate the drive in a direction so as to cause loading of the elongate windable element by the spatial loading system, and wherein the controller is further selectably operable to operate the drive in reverse, thereby to cause unloading of the elongate windable element from the spatial loading system.

Additionally, one or more of the loading members is revolvable, and wherein the transmission is also operative to transmit thereto, a second rotational motion from the drive.

Further, there are provided a plurality of generally cylindrical loading members mounted for rotation about a central axis.

Additionally, the spatial loading system is mounted within the enclosure onto a central support axis defining the central axis and is adapted for selectable rotation thereabout.

Further, the treatment apparatus includes at least two mutually independently operable treatment sources for treating the elongate flexible element in at least two mutually independent treatment zones.

Additionally, one or more of the treatment sources is a temperature treatment apparatus.

Further, two or more of the treatment sources are mounted within the enclosure and are mutually independently operable, each being operable at a selected temperature so as to define at least two independently controllable temperature treatment regions within the enclosure.

Additionally, the elongate flexible element is marked with a marking substance and after entry into the enclosure through the inlet port, the spatial loading system is operative to expose the substance bearing elongate flexible element to a predetermined treatment by the treatment apparatus for a desired dwell time.

Further, the elongate flexible element is a dyed thread, the treatment unit is a dryer, and the treatment apparatus includes one or more heat sources operative to dry the thread prior to its egress from the dryer.

In accordance with an additional embodiment of the present disclosure, there is provided a substantially sealed enclosure for the through-processing of a continuously through-flowing elongate flexible element bearing a treatable substance which emits materials sought to be contained during treatment in the enclosure, which includes:

(a) a plurality of walls defining an interior;

(b) an inlet port for the continuous ingress of an elongate flexible element into the interior;

(c) an outlet port for the continuous egress of the treated elongate flexible element;

(d) treatment apparatus located within the enclosure, for treating the elongate windable element therein, giving rise to the release of materials sought to be contained within the enclosure; and

(e) pressure-reducing apparatus operative to cause a localized reduction in pressure within the enclosure.

Additionally, the pressure-reducing apparatus includes a blower for gas circulation within the enclosure, operative to cause a reduction in pressure in an area adjacent to the inlet port.

Further, the substantially sealed enclosure also includes:

a suction device for removing gas from the interior of the enclosure; and

apparatus for collecting the materials sought to be contained so as to prevent their release into the atmosphere exterior to the enclosure.

In accordance with a further embodiment of the present disclosure, there is provided a collection unit for handling of a continuous through flow of an elongate windable element, the collection unit including:

(a) an enclosure for the through-processing of a continuously through-flowing elongate windable element, the enclosure having an inlet port for the continuous ingress of the elongate windable element and an outlet port for the continuous egress of the elongate windable element; and

(b) a spatial loading system located within the enclosure, for continuous collection and paying out of the elongate windable element within the enclosure, and for conveying the elongate windable element from the inlet port to the outlet port.

Additionally, the inlet and outlet ports are spaced apart by a predetermined linear distance, the spatial loading system includes one or more loading members having a non-linear loading surface for winding the elongate windable element therealong along a non-linear loading path,

and wherein the length of the loading path is of a magnitude which is at least three times the linear distance between the inlet and outlet ports.

Further, each of the one or more loading members has a generally cylindrical surface for receiving the elongate windable element in a wound arrangement.

Additionally, one or more of the loading members is revolvable, and the spatial loading system also includes a drive for rotation thereof.

Further, the non-linear loading path is serpentine.

Additionally, the one or more loading members include a plurality of discrete loading members defining nodes along the serpentine loading path.

Further, the plurality of discrete loading members includes first and second opposing arrangements of discrete loading members, and wherein on loading, the elongate windable element becomes wound alternately about opposing loading members of each of the first and second arrangements, along the serpentine loading path.

Additionally, the inlet port is a slotted opening for the lateral insertion of a length of the elongate winding element into the enclosure;

the first arrangement of discrete loading members is arranged in a predetermined mutual spatial relationship relative to the slotted opening so as to receive the elongate winding element therefrom;

the second arrangement of discrete loading members is movable relative to the first arrangement and the slotted opening between a first position and a second position,

wherein, in the first position, the second arrangement is disposed such that the slotted opening is disposed between the first and second arrangements,

and in the second position, the second arrangement is disposed distally from the slotted opening such that the first arrangement is positioned therebetween;

wherein each loading member of each of the first and second arrangements is spaced apart so as to enable passage of the second arrangement of discrete loading members through the first arrangement of discrete loading members when moving between the first and second positions; and

wherein when the second arrangement is located in the first position and a length of the elongate windable element is introduced laterally through the slotted opening so as to overlie the first arrangement of discrete loading members, the second arrangement is operative to translate towards the second position, through the first arrangement of discrete loading members, towards the second position, so as to engage the elongate windable element and to pull it through the members of the first arrangement along the serpentine loading path.

In accordance with yet a further embodiment, the spatial loading system also includes a rotational winding arm for engaging the elongate windable element so as to wind it around the one or more loading members.

Additionally, the loading path is helical, and the one or more loading members are configured to receive the elongate windable element thereabout in a helical arrangement, of which adjacent coils are non-touching.

Further, the exterior of each of the one or more loading members is contoured so as to define the helical loading path.

Additionally, the spatial loading system also includes:

a drive;

a transmission for transmitting a rotational motion from the drive to the rotational winding arm; and

a controller for controlling the operation of the drive,

the controller operative to adjust the drive in a manner so as to adjust the dynamic conditions at which the spatial loading system collects the elongate windable element and conveys the elongate windable element from the inlet port to the outlet port of the enclosure.

Further, the controller is operable to normally operate the drive in a direction so as to cause loading of the elongate windable element by the spatial loading system, and wherein the controller is further selectably operable to operate the drive in reverse, thereby to cause unloading of the elongate windable element from the spatial loading system.

Additionally, one or more of the loading members is revolvable, and wherein the transmission is also operative to transmit a second rotational motion thereto, from the drive.

Further, there are provided a plurality of generally cylindrical loading members mounted for rotation about a central axis.

Additionally, the spatial loading system is mounted within the enclosure onto a central support axis defining the central axis and is adapted for selectable rotation thereabout.

In accordance with yet a further embodiment of the present disclosure, there is provided a multi-station system of processing a continuous throughflow of an elongate windable element, which includes:

(a) at least first and second treatment units for the through flow and treatment of an elongate windable element, the second treatment unit being operable to normally receive from the first treatment unit an outflow of elongate windable element treated therein in a continuous process,

wherein the first treatment unit is operative to emit therefrom the elongate windable element at a first rate of travel, and the second treatment unit is operative to intake the elongate windable element at a second rate of travel, and

wherein the first and second rates are different one from the other; and

(b) a collection unit disposed between the at least first and second units, adapted for selectably receiving and collecting a throughflow of the elongate windable element from the first treatment unit at the first rate, and for providing the elongate windable element to the second treatment unit at the second rate, wherein the collection unit is operative to selectively collect the through flowing element at a rate selected to change the rate of travel of the through flowing element from the first rate to the second rate.

Additionally, each of the at least first and second treatment units is constructed and operative in accordance with any of the treatment units disclosed herein.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIG. 1 is a schematic block diagram of a multi-station processing system for treating an elongate windable element in accordance with an embodiment of the present invention;

FIG. 2 is a schematic block diagram of a multi-station processing system for the preparation of articles of manufacture formed of colored fabric or thread, including a dyeing station and a dryer;

FIG. 3A is a generalized schematic diagram of a treatment unit, such as the dryer of FIG. 2, constructed in accordance with an embodiment of the present invention;

FIG. 3B is similar to FIG. 3A, except including a plurality of treatment zones within the unit;

FIG. 4 is a schematic illustration of a spatial loading system for collection and paying out of an elongate windable element, as used in the systems and units of FIGS. 1-3B, in accordance with a first embodiment;

FIG. 5 is a schematic illustration of a spatial loading system for collection and paying out of an elongate windable element, as used in the systems and units of FIGS. 1-3B, in accordance with a second embodiment;

FIG. 6 is a perspective view of a treatment unit employing a serpentine spatial loading system as depicted in FIG. 4, implemented as a dryer unit for a multi-station system for dyeing thread;

FIG. 7 is a longitudinal cross-sectional view of the dryer unit of FIG. 6;

FIG. 8 is a lateral cross-sectional view of the dryer unit of FIG. 6, perpendicular to the view of FIG. 7;

FIGS. 9A and 9B are rear and front views, respectively, of the serpentine spatial loading system of FIGS. 6-8;

FIG. 10A is a partially cut-away top view of the dryer unit of FIG. 6, prior to feeding thereinto of a dyed thread;

FIG. 10B is an enlarged partially cut-away top view of the dryer unit of FIG. 6, showing initial placement of a dyed thread onto a first set of loading members of the serpentine spatial loading system therein;

FIG. 11A is a schematic representation of first and second sets of the serpentine spatial loading system of FIGS. 4 and 6-10B, in a non-loaded position;

FIG. 11B shows the system of FIG. 11A during initial loading of an elongate flexible element;

FIG. 11C shows the system of FIGS. 11A and 11B after initial loading thereof;

FIG. 11D shows the system of FIGS. 11A-11C when fully loaded;

FIG. 11E is a schematic illustration showing the taking up of elongate flexible element by a single discrete loading member;

FIG. 12A is a perspective view of a treatment unit employing a rotational spatial loading system as depicted in FIG. 5, implemented as a dryer unit for a multi-station system for dyeing thread;

FIG. 12B is a partially cut away view of the treatment unit FIG. 12A, with the inlet port in an open state;

FIGS. 13A, 13B and 13C are respective front, rear and side views of the treatment unit as seen in FIG. 12B;

FIG. 14 is a partially cut away view of the treatment unit of FIGS. 12A-13C;

FIG. 15A is a diagrammatic side view of the rotational winding arm of FIGS. 12A-14, showing its rotational path while winding the elongate flexible element onto the rotational spatial loading system of FIGS. 12A-14;

FIG. 15B is a front view of the rotational winding arm of FIGS. 12A-14, showing translation of the winding head along the winding arm, resulting in a helical winding of the elongate flexible element onto the loading members of the rotational spatial loading system;

FIGS. 15C and 15D are schematic views showing winding of the elongate flexible element onto the loading members of the rotational spatial loading system;

FIG. 16 is a schematic block diagram of a multi-station process for processing an elongate windable element in an uninterrupted manner; and

FIG. 17 is a schematic block diagram of a buffer unit as seen in FIG. 16.

### DETAILED DESCRIPTION

The terms used herein denote also inflections and conjugates thereof. Unless otherwise noted, technical terms are used according to conventional usage. Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” The abbreviation, “e.g.” is derived from the Latin exempli gratia and is used herein to indicate a non-limiting example. Thus, the abbreviation “e.g.” is synonymous with the term “for example.”

In case of conflict, the present specification, including explanations of terms, will control. In addition, all the materials, methods, and examples are illustrative and not intended to be limiting.

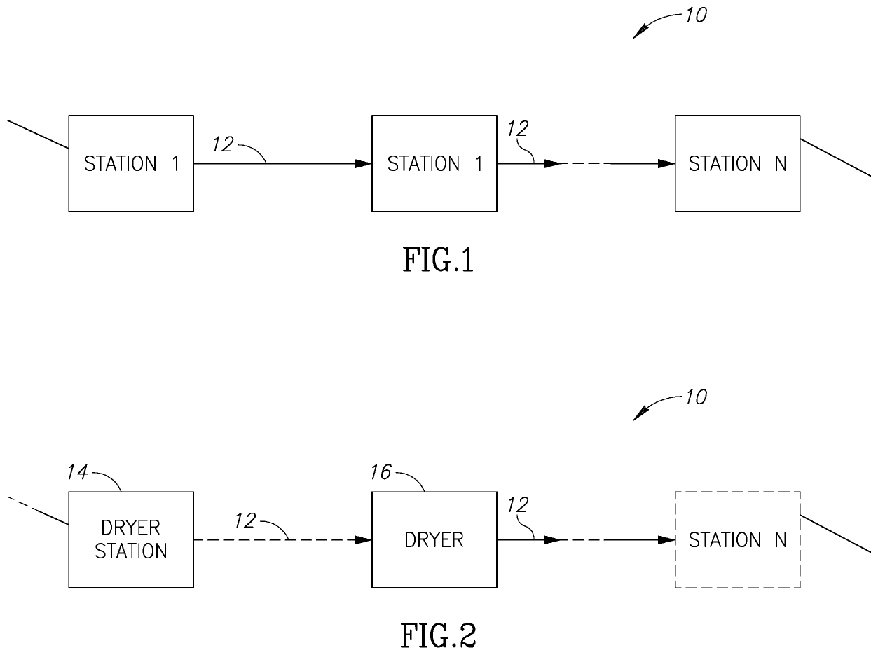

Referring now to FIG. 1, there is a provided a multi-station processing system, indicated generally by reference numeral 10, for treating an elongate windable element 12 in accordance with an embodiment of the present invention. Element 12 may be a fiber or synthetic thread, as used, for example, in the textile industry, a wire filament or wires requiring surface coatings, or indeed any other type of windable element that may lend itself to a continuous through processing as described herein.

In its most general form, system 10 includes a plurality of processing stations through which element 12 flows substantially continuously.

As seen in FIG. 2, in one embodiment, processing system 10 may be a system for treating an element 12 with a marking substance requiring a post-marking treatment, and, more specifically, a thread dyeing system including, but not limited to, a dyeing station 14 and a dryer 16. There may also be other stations upstream of dyeing station 14, and one or more optional downstream stations N, for further processing the thread and, optionally, for collecting the dyed and dried thread or for feeding into fabric manufacturing and processing stations (not shown). Such systems may be, by way of non-limiting examples, those disclosed in WO 2017/013651 entitled An Integrated System and Method for Treating a Thread and Using Thereof, and WO 2017/203524 entitled System, Machine and Method for Treating Threads or Parts Thereof.

Dyeing station 14 is generally intended to mean a station for applying a dye to a thread, for example, as described in the above-referenced WO 2017/013651, and dryer 16 is intended to mean a treatment unit into which dyed thread enters in a continuous throughflow from dyeing station 14, undergoes a drying process as described below, and thereafter exits. It will thus be appreciated that unless specified to the contrary, the terms ‘treatment unit’ and ‘dryer’ are used interchangeably herein.

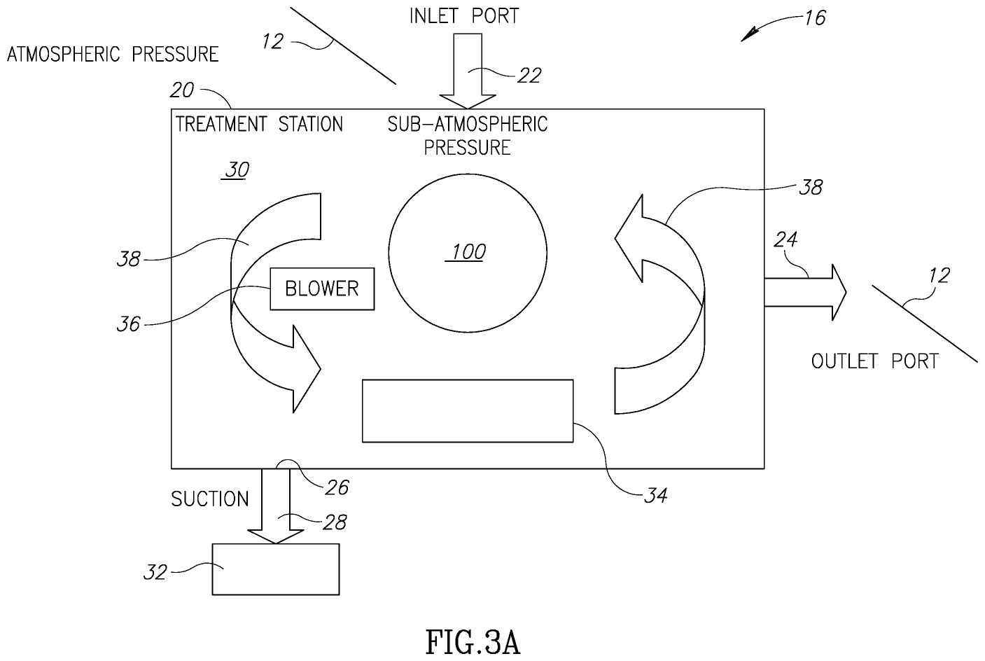

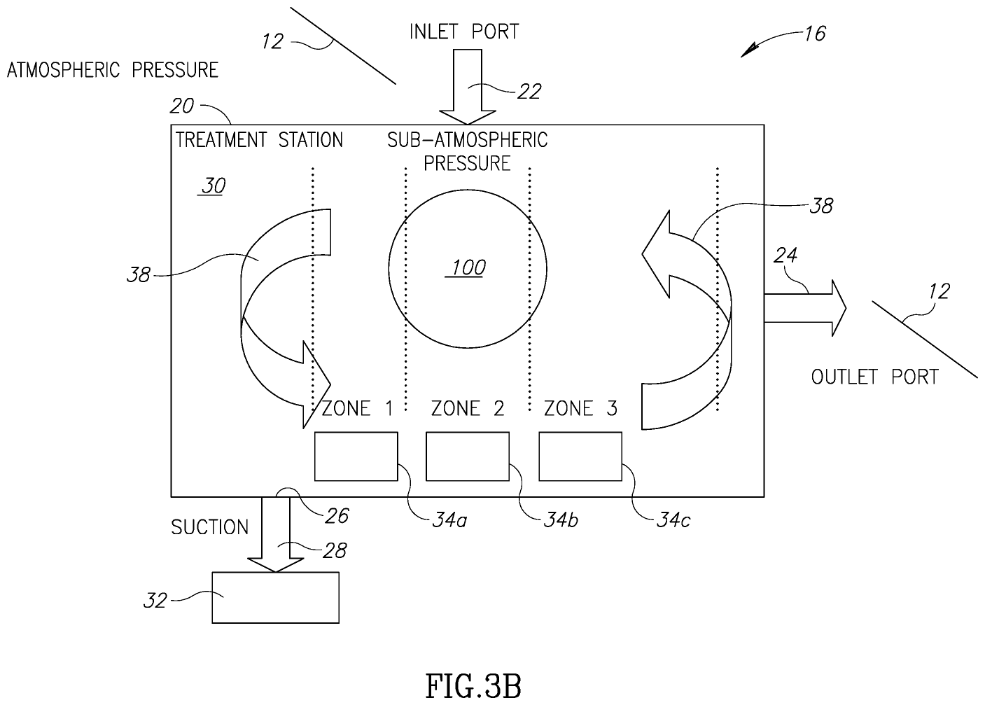

Referring now to FIG. 3A, there is shown a treatment unit, such as the dryer 16 of FIG. 2. From the description below, it will be appreciated that treatment unit 16 has a number of advantages, including its ability to treat element 12 during a predetermined dwell time within unit 16, as it passes therethrough, and the ability to contain certain process materials that may be released into the interior gaseous environment of unit 16 during the treatment.

As seen in FIG. 3A, unit 16 includes a substantially sealed enclosure 20, a spatial loading system 100 for collection and paying out of element 12 for treatment within unit 16, and along which element 12 travels before leaving the enclosure, and apparatus for treating the element 12, as described below.

It will be appreciated that unit 16 is not limited by scale or size. Accordingly, enclosure 20 within which element 12 is collected, and within which a treatment may be provided as described herein, may be of any predetermined size, varying from a small tabletop device, to the size of a room or hall used for major industrial production.

Substantially sealed enclosure 20 has an inlet port 22 for the continuous ingress of elongate windable element 12 and an outlet port 24 for the continuous egress of treated elongate windable element. Preferably, there is also provided a gas exit 26, a suction device 28 for removing gas from the interior 30 of enclosure 20, and containing apparatus 32 for process materials sought to be contained and prevented from exiting into the environment outside enclosure 20

The treatment apparatus disposed within enclosure 20 is a function of the treatment required. In the present example, in which unit 16 is a dryer, the treatment required may be temperature related, such that apparatus 34 may be a heater or a cooler; or any other type of treatment which may be beneficial to element 12 flowing through unit 16

Optionally, in accordance with some embodiments, there may also be provided a blower 36 for circulating the gas environment within enclosure 20, as indicated by arrows 38.

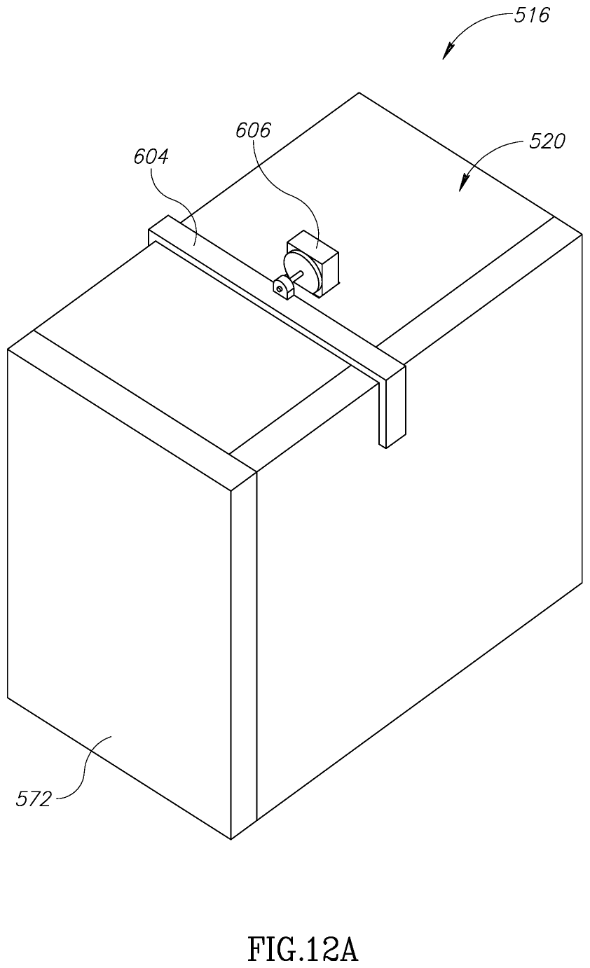

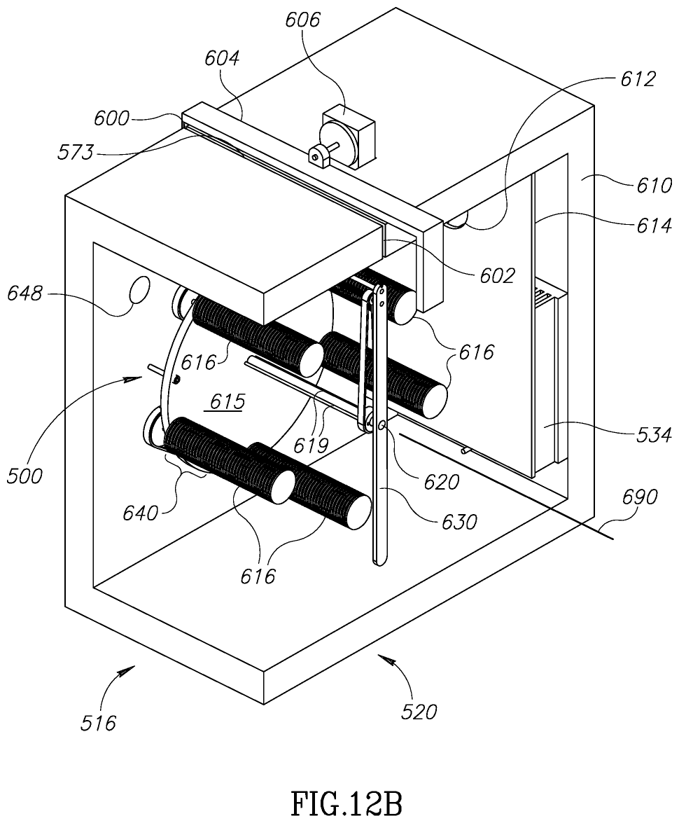

In accordance with a preferred embodiment, for example, as shown and described in conjunction with FIGS. 12A-15 below, blower 36 is configured and operative so as to locally reduce the pressure within the interior of enclosure 20, and particularly in the area close to inlet port 22 and outlet port 24, to a pressure that is sub-atmospheric. It will thus be appreciated that while, in the presently described embodiment enclosure 20 is not mechanically sealed, it is however deemed to be substantially sealed in as far as, due to the pressure reduction in the vicinity of inlet port 22, outlet port 24 and gas exit 26, process materials that may be emitted from the treated element 12 into the gas environment of enclosure 20 as it passes therethrough are prevented from exiting into the ambient atmosphere outside enclosure 20 and contained therewithin, as described above.

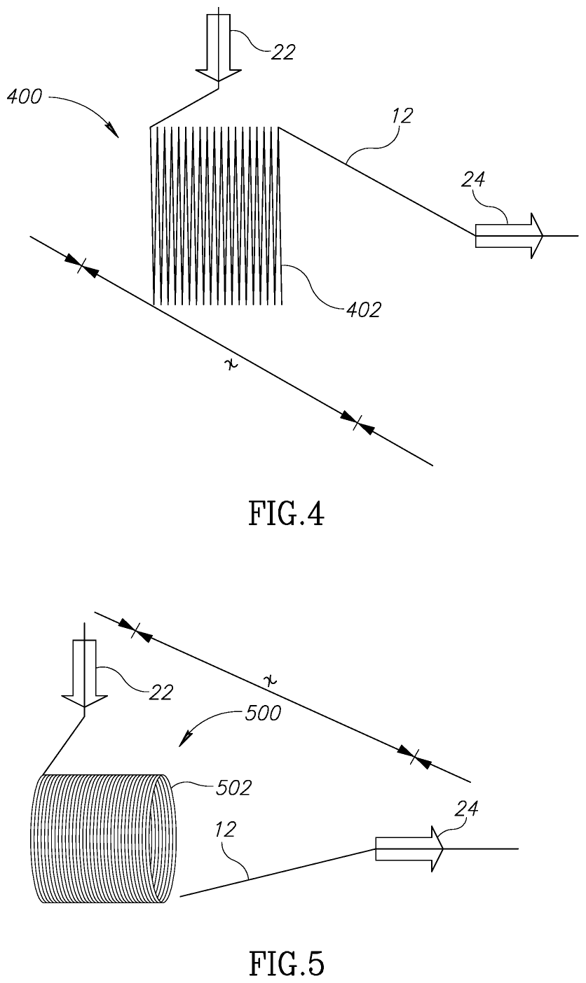

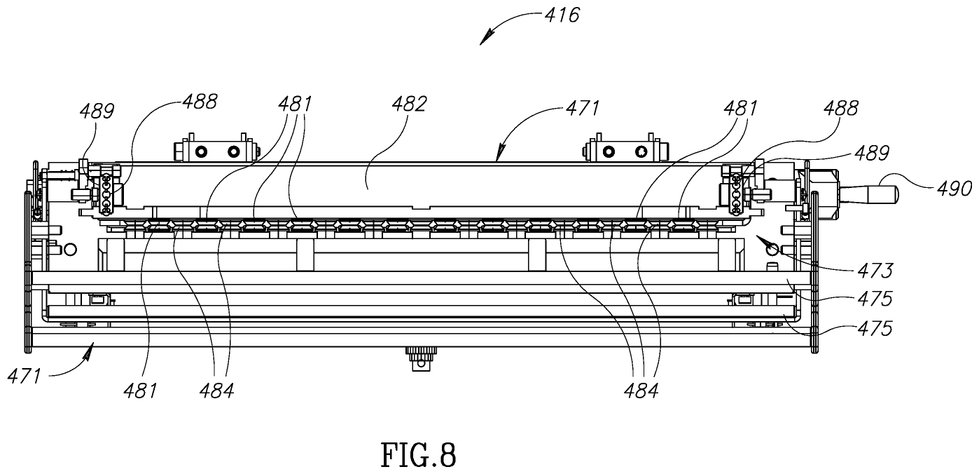

The treatment unit 16 generally, when in use as a dryer, and spatial loading system 100 in particular, are described in detail hereinbelow, in accordance with various embodiments, in conjunction with FIGS. 4-15B.

Referring now briefly to FIG. 3B, there is shown a unit 16 which is generally similar to that shown and described above in conjunction with FIG. 3A, of which common or similar features are denoted with the same reference numerals as used in FIG. 3A, and which is not described specifically herein except with regard to the differences between the two illustrated unit.

In an alternative embodiment, as illustrated in FIG. 3B, unit 16 may be used to provide a plurality of different treatment zones within enclosure 20. Thus, by way of non-limiting example, three such zones are depicted, denoted as zones 1, 2 and 3. In one example, zones 1, 2 and 3 may be at different temperatures, such as may result in a succession of temperature changes, whether relatively hot or cold. Furthermore, in another embodiment, one or more of the zones may have thereat another type of treatment apparatus, in conjunction with temperature treatment apparatus. The different treatment apparatus for each zone are referenced 34a, 34b and 34c, respectively.

As described above, unit 16 includes a spatial loading system 100 for collection and paying out of element 12. A particular feature of system 100 is that it facilitates the collection and throughflow of a length of the element 12 along a loading path which is at least triple, and may be significantly greater than the linear distance between the inlet and outlet ports of enclosure 20.

As illustrated in FIG. 4 in which the spatial loading system, referenced 400, is depicted as having a serpentine loading path 402, the total length of the thread along the loading path is seen to be significantly greater than the distance ‘x’ between the inlet and exits ports 22 and 24.

Similarly, in FIG. 5, in which the spatial loading system, referenced 500, is depicted as having a helical loading path 502, the total length of the thread along the loading path is seen to be significantly greater than the distance ‘x’ between the inlet and exits ports 22 and 24.

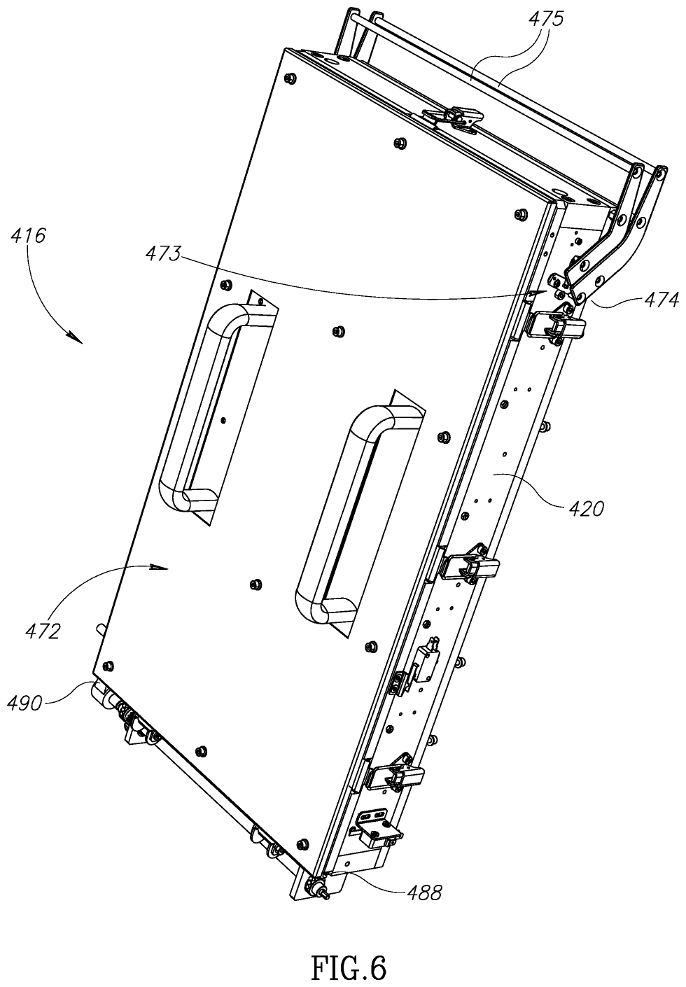

Reference is now made to FIGS. 6-8, in which is depicted a treatment unit employing a serpentine spatial loading system as depicted schematically in FIG. 4 optionally implemented as a dryer unit 416 for a multi-station system for dyeing thread, as per FIGS. 2-3B. Features of present dryer unit 416 that are generally similar to those shown and described above in conjunction with FIG. 3A, are denoted by similar reference numerals but with the prefix “4” and are not specifically described again herein.

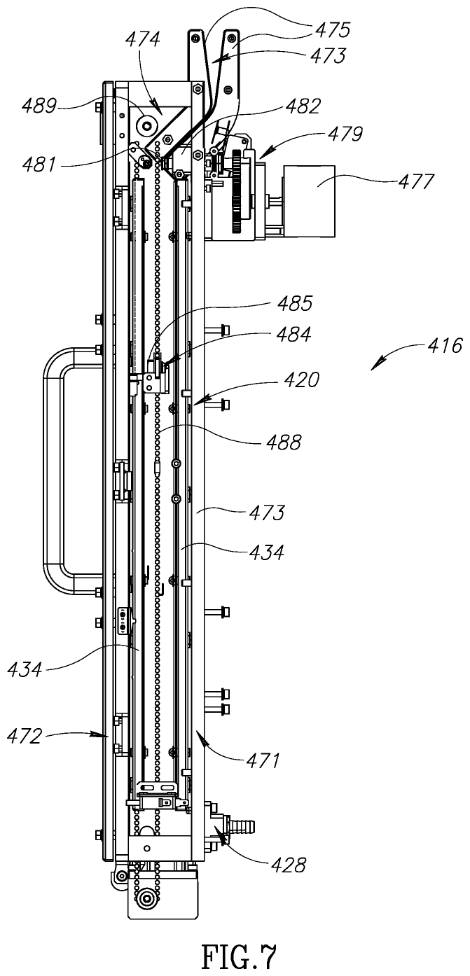

Dryer unit 416 has a generally flat configuration, in which enclosure 420 has a generally flat, rectangular configuration, having a removable cover 472. Typically, a pair of generally flat heating elements 434 (FIG. 7) are positioned to the interior of an optionally insulated rear panel 473 and cover 472 for drying element 12 passing through unit 416. Optionally, there is also provided a suction device 428 (FIG. 7) located at a lower portion of unit 416 for inducing a flow of gas away from the inlet port 422 and so as to remove gas from the interior of the enclosure as disclosed.

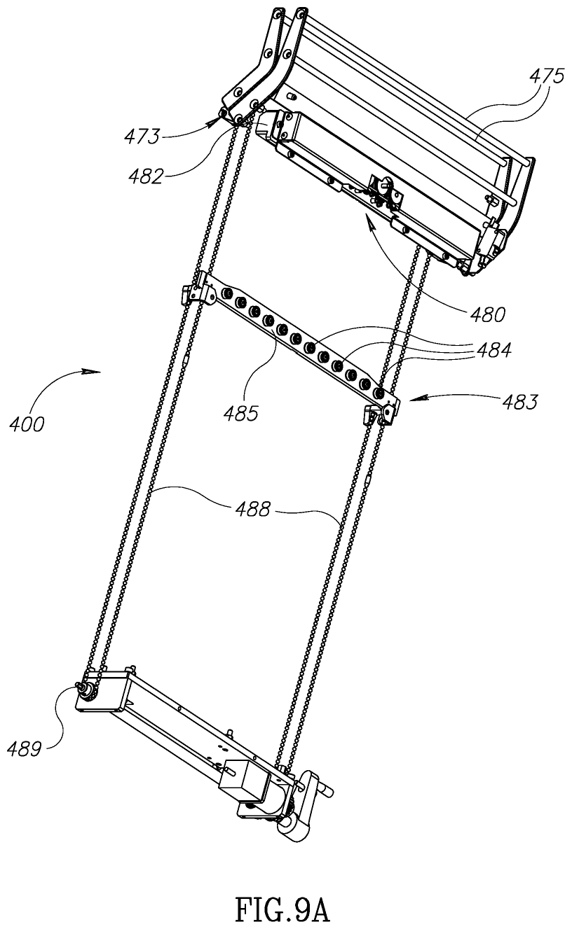

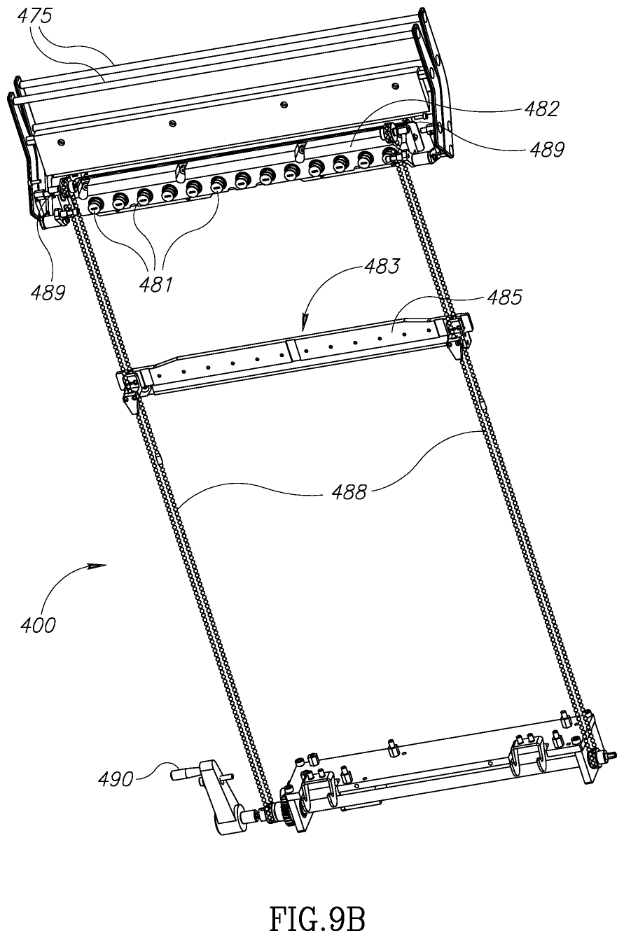

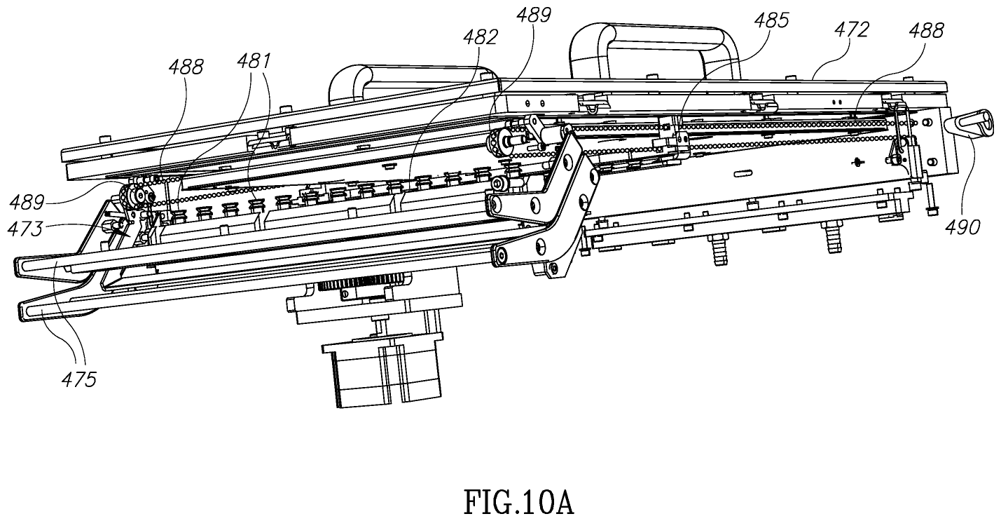

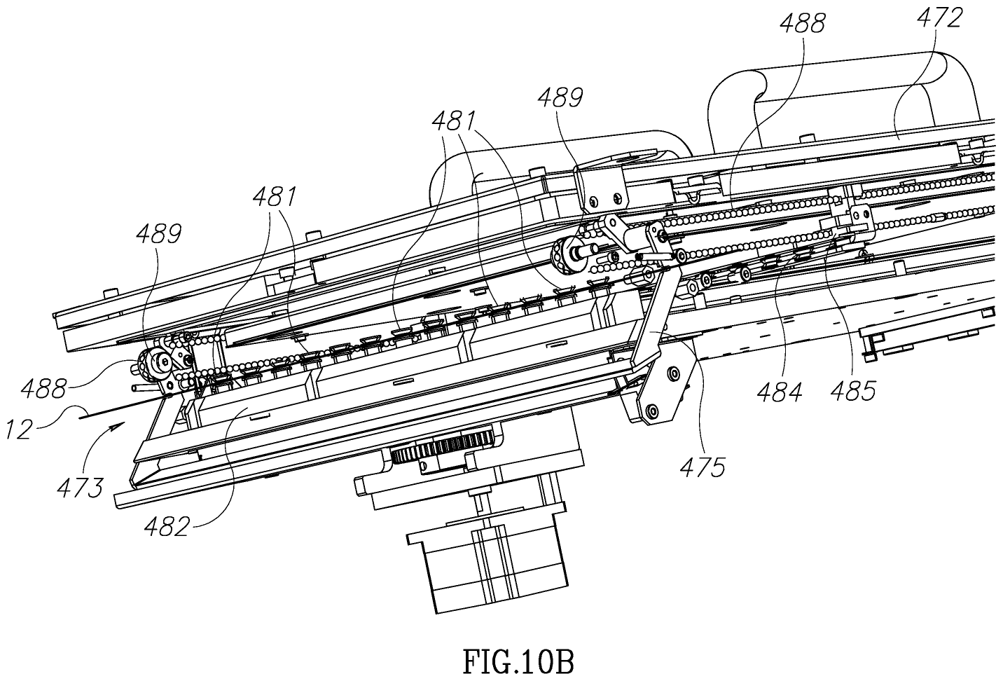

Referring now also to FIGS. 9A-10B, a preferably slotted opening 473 is provided at an end portion 474 (FIG. 7) of enclosure 420 so as to receive therethrough in intake of element 12, as described below, by use of a pair of guide members 475 (FIGS. 6-10B and 11B). Clearly, the illustrated pair of guide members may be replaced by any other suitable guide means.

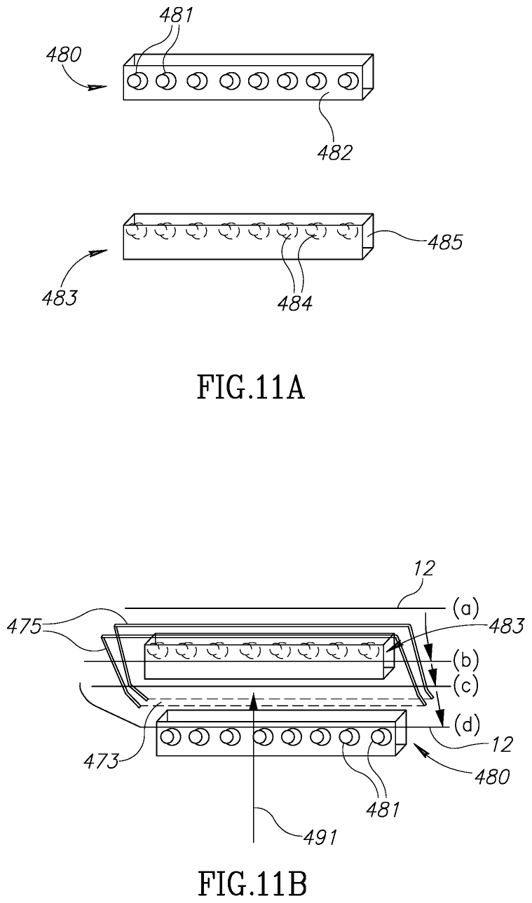

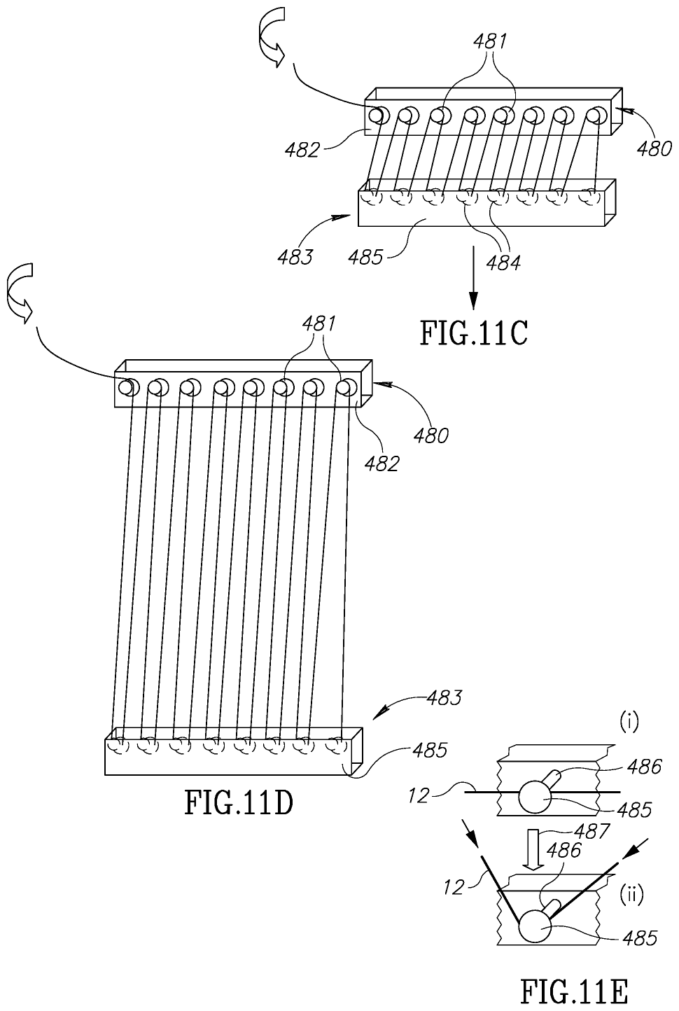

Referring now also to FIGS. 11A-11D, serpentine spatial loading system 400, whose operation is independent of the use of unit 416 as a dryer, per se, includes a first arrangement 480 of discrete loading members 481 mounted onto a first bridge member 482; and a second arrangement 483 of discrete loading members 484 mounted onto a second bridge member 485. The two arrangements of discrete loading members, 480 and 483, are arranged in a predetermined mutual spatial relationship relative to slotted opening 473 so as to receive element 12 therefrom. loading members 481 of first arrangement 480 may be rotated as by a motor 477 (FIG. 7) and a suitable transmission, referenced generally 479. One or more loading members 481 may be rotated by motor 477, as required, so as to assist with the control of the throughflow of element 12 at desired dynamic conditions, such as tension and/or speed. Alternatively, loading members 481 may be mounted for passive rotation, on bearings, or static, optionally with a suitable low-friction coating. Loading members 484 of the second arrangement 483 may be similarly static, passively rotatable or motorized. In the present example, loading members 484 are passively rotatable, mounted on suitable bearings.

In the illustrated embodiment, first arrangement 480 is secured so as to have a position that is fixed relative to slotted opening 473, such that when a length of element 12 is inserted laterally through opening 473 it overlies first arrangement 480 of discrete loading members 481 (FIGS. 10B and 11B).

Second bridge member 485 of second arrangement 483 is mounted, as seen particularly in FIGS. 9A-9B, onto a pulley system, having a pair of belts or chains 488 each mounted about a pair of pulley wheels 489 affixed at opposite ends of the enclosure. The pulley system can be activated either manually, as by a handle 490, or by a suitable motor (not shown) so as to move the second arrangement 483 between first and second extreme positions, in order to load the present serpentine spatial loading system. In the first position, seen in FIG. 11B, second arrangement 483 is positioned distally from the first arrangement 480, such that the slotted opening is disposed between the first and second arrangements. In the second position, seen in FIG. 11D, second arrangement 483 is disposed distally from the slotted opening such that first arrangement 480 as illustrated.

It is further seen that the first and second arrangements 480 and 483 are spaced apart, as well as being staggered, one relative to the other, so as to enable passage of the second arrangement of discrete loading members through said first arrangement of discrete loading members when moving between the first and second positions

Referring now briefly to FIG. 11E, so as to assist in preventing the element 12 from slipping off the discrete loading members 481 and 484 when engaged thereby, each loading member generally enlarged head portion 485 and a reduced diameter waist or neck portion 486. As seen, for example, particularly in FIGS. 10A and 10B, loading members 481 and 484 are provided as V-shaped ‘pin’ members. In a further embodiment, slippage of element 12 may alternatively be prevented by creating a surface with desired frictional properties on an otherwise cylindrical member. Preferably, however, and as further illustrated in FIG. 11E, lateral engagement of a taut length of element 12 by a neck portion 486 of a loading member, seen at position (i), causes element 12 to be snagged thereby, such that a subsequent continued movement of the loading member, indicated by arrow 487, towards position (ii), pulls the element 12 along with it.

Referring now particularly to FIG. 11B, in order to load the system, second arrangement 483 is moved to its first position, as shown by arrow 491, so as to be above both the first arrangement 480 and above the slotted opening 473. Subsequently, a length of element 12 is inserted between the angled guide members 475. As seen in FIG. 11B, element 12 is initially moved from position (a), then successively to positions (b) and (c), as it is guided towards and through the slotted opening 473 so as to emerge therethrough in position (d), and laid across the top of the discrete loading members 481 of the first arrangement 480.

The second arrangement 483 is then moved such that its loading members 484 pass through the first loading members 481, so as to engage the element 12 in the manner shown and described in conjunction with FIG. 11E, and thus to pull element 12 through the loading members of first arrangement 480, as seen initially in FIG. 11C, and more completely in FIG. 11D, along serpentine loading path 402, as illustrated in FIG. 4.

Referring now to FIGS. 12A-14, there is provided, in accordance with an alternative embodiment, a treatment unit 516 for treating a continuous throughflow of an elongate, flexible element, such as elongated windable element 12 of FIG. 1. In the present example, unit 516 is implemented as a post-marking unit, as discussed above in conjunction with FIG. 2, for treating a continuously through-flowing marked substance, and more specifically, as a dryer (such as seen in FIG. 2) for drying a continuously through-flowing dyed thread as may be received from dyeing station 14.

Unit 516 includes a substantially sealed enclosure 520 for containing a gaseous environment, having an inlet port 602 (FIG. 12B) for the continuous ingress of an elongate windable element, and an outlet port 600 (FIG. 12B) for the continuous egress of treated elongate windable element. Enclosure 520 preferably has an access door 572 to provide an operator or a maintenance personnel with access to the interior of the enclosure so as to perform maintenance to the interior of treatment unit 516. In the present embodiment, the inlet and outlet ports 602 and 600, respectively, are seen to be constituted by opposite ends of a slotted opening 573 (FIGS. 12B-14). A slidable closure member 604 (FIGS. 12A-12B) is mounted onto enclosure 520 for substantially sealing opening 573 after initial introduction thereinto of element 12. Operation of closure member may be manual or as by use of a suitable drive, indicated schematically as 606.

Treatment unit 516 houses a rotational spatial loading system 500 within enclosure 520, for continuous collection and paying out of the elongate windable element therewithin, and for conveying the elongate windable element from inlet port 602 to outlet port 600 after a desired dwell time within enclosure 520. The dwell time is determined, inter alia, according to the type of treatment performed within enclosure 520, the material of which element 12 is composed, and the rate at which element 12 is passed through unit 516. In accordance with the embodiment of FIG. 5 above, in which loading path 502 is generally helical, the herewith illustrated spatial loading system 500 has a plurality of generally cylindrical loading members or bobbins 616.

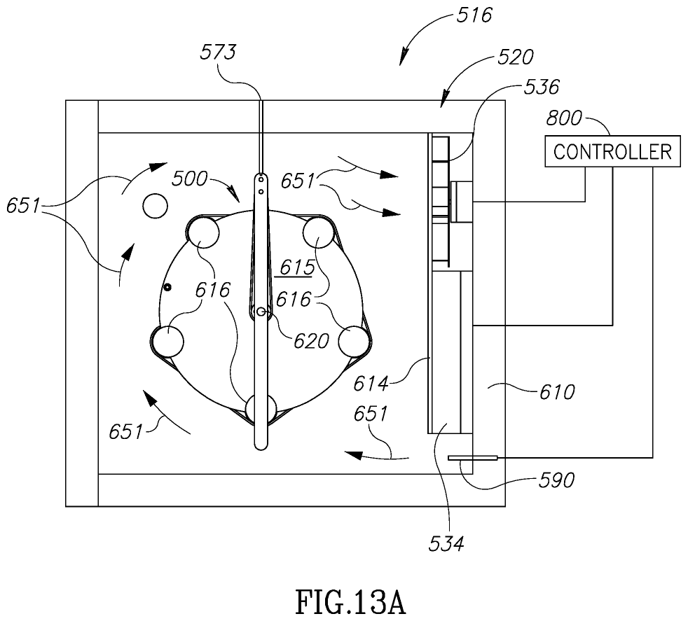

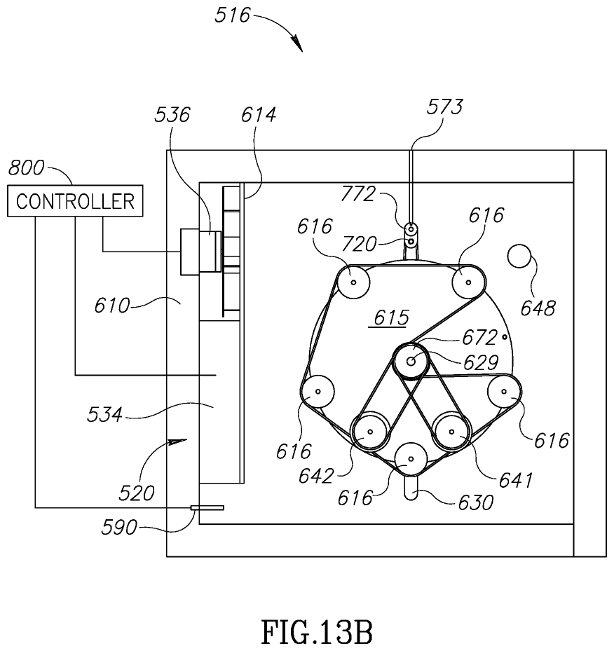

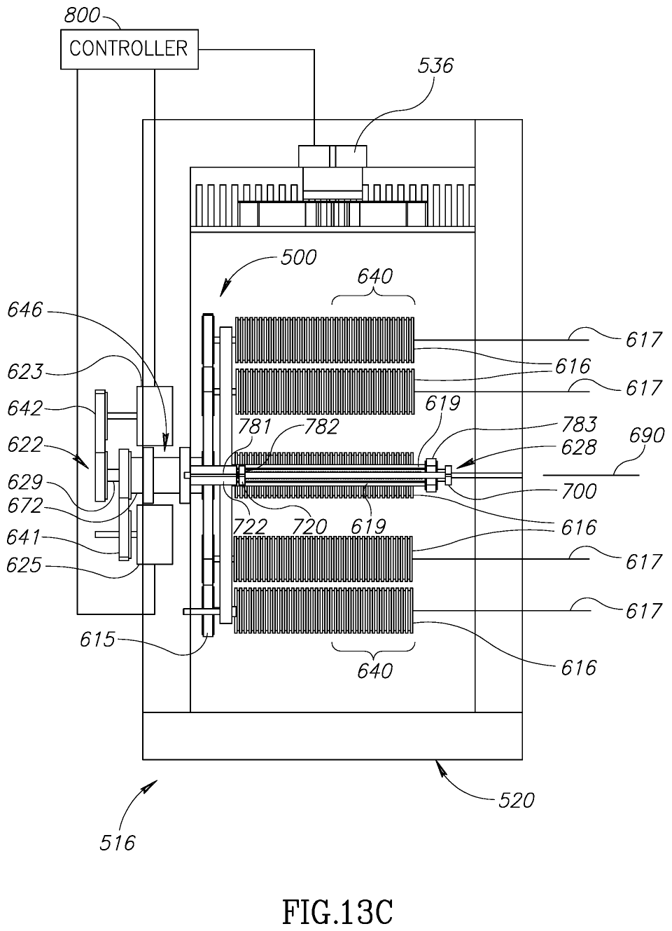

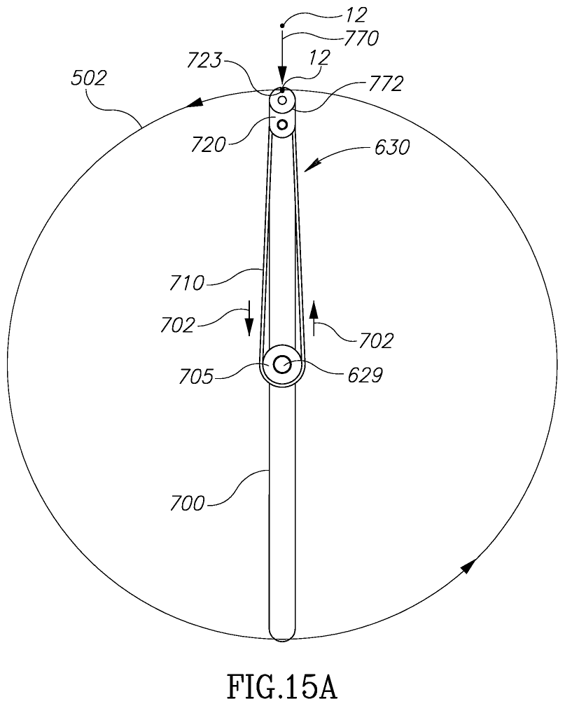

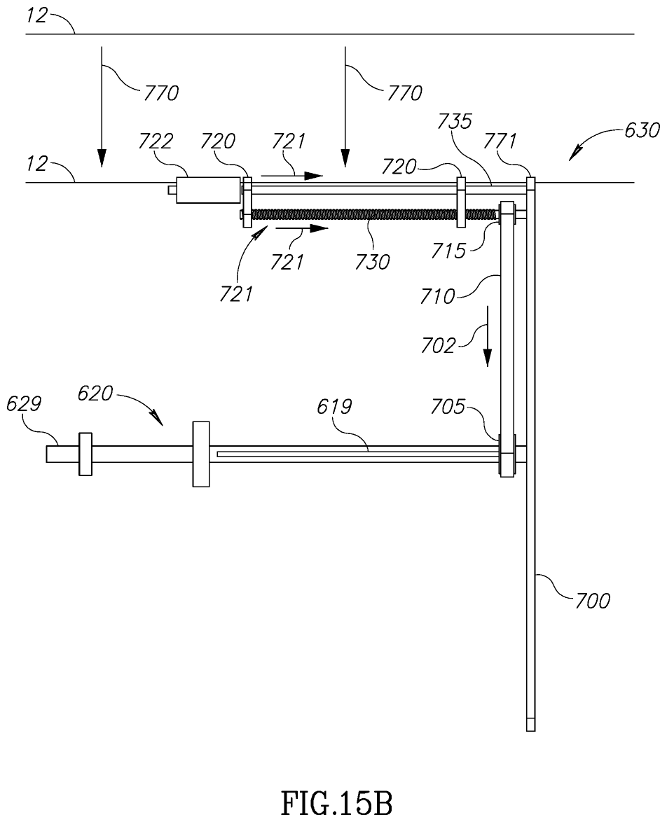

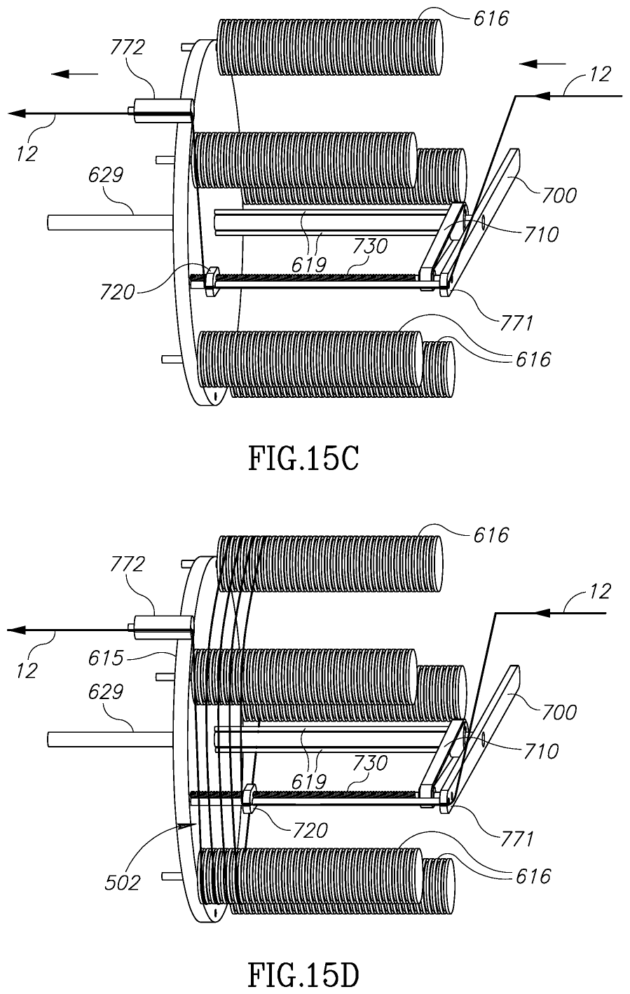

As seen in FIGS. 12B and 13C, bobbins 616 are preferably contoured, as by the provision of grooves, referenced generally as 640, so as prevent touching of adjacent coils of the element 12 when wound therearound. In various embodiments of the invention, bobbins 616 may be smooth, contoured as shown, cylindrical or conical, and mounted at various non-mutually parallel angles, or any desired combination, so as to both ensure a precise positioning of element 12 as it is collected thereon, and preferably to prevent touching of adjacent coils of the element 12 when wound onto the bobbins. In accordance with an alternative embodiment, and as may be understood with reference to FIGS. 15C and 15D there may also be provided a comb or separator element (not shown), on or adjacent to one or more of bobbins 616. This may be any type of bladed or toothed comb or separator known in the textile industry. One especially useful positioning of such a comb or separator element is where element 12 exits via exit port 600 (not shown) via guide 772, along the path illustrated in FIGS. 15C and 15D.

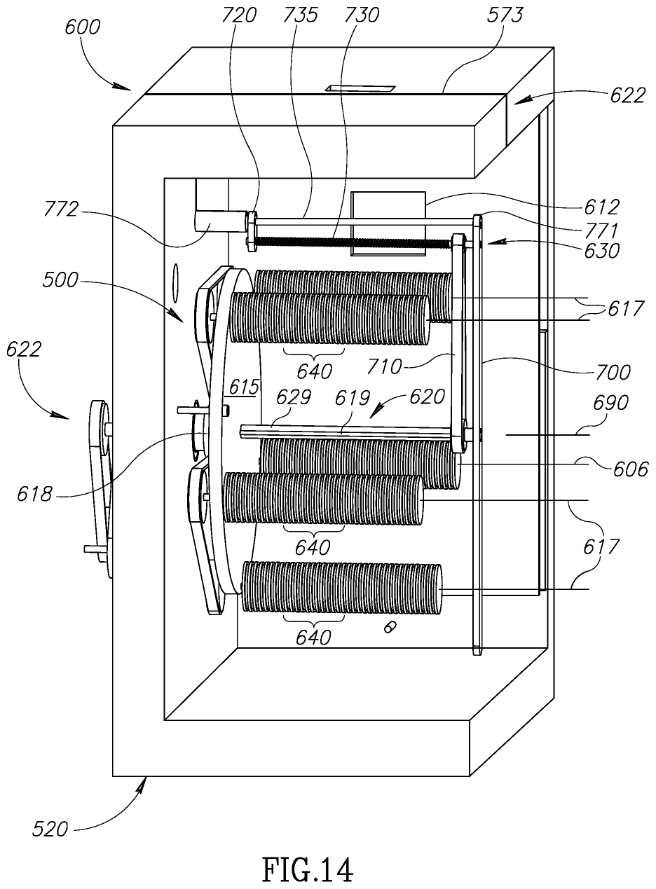

A winding system, referenced 630, is also provided, in association with rotational spatial loading system 500, for winding the flexible element 12 thereon, as described below. In the present embodiment, bobbins 616 are rotatable, as described below, and are distributed about a central axis 690 (FIG. 14), which may also serve as a rotation axis of winding system 630. One or more bobbins 616 may be rotatable independently, as required, so as to assist with the throughflow of element 12 at a desired tension and speed. Alternatively, one or more of the bobbins 616 may be mounted onto a base 615 for passive rotation, on bearings, or static but with a surface having desired frictional properties.

In the present example, each bobbin 616 is mounted for rotation about a bobbin axis 617, which typically is its longitudinal axis of symmetry.

As seen in FIG. 13B-13C, treatment unit 516 includes a winding drive 623 operative to drive winding system 630 thereby winding the flexible element 12 onto rotational spatial loading system 500. A rotational driving force is transferred from winding drive 623 to winding system 630 via winding drive shaft 629 which is driven by winding transmission 642 connected to the output of winding drive 623.

Treatment unit 516 also includes a rotation drive 625 operative to rotate bobbins 616 about their respective bobbin axes 617. The direction of rotation is preferably opposite to the direction of winding, so as to reduce friction and tension on element 12, as it is wound thereabout. Bobbins 616 are rotated by a rotational driving force which is transferred from rotation drive 625 to rotation gear 618 (FIG. 14), via rotation transmission 641, and then to rotation drive gear 627. Drive element 618 is connected with loading members 616 by a driving chain or belt 672 or other suitable mechanism to transmit a drive force from a transmission 622.

In the present example, in order to limit the number of access points between the interior and exterior of enclosure 520, winding drive shaft 629 extends through the center of rotation drive gear 627, such that a single access opening only, is required therefor.

A further advantage of having the spatial loading system 500 mounted on a single axis is the access that this facilitates to the system, for maintenance. When required, front cover 572 (FIG. 12) may be removed, and system 500 rotated about axis 690 (FIG. 14) to any desired position, thereby providing access to any desired portion of the system.

As mentioned briefly above and is illustrated in FIG. 13C, a controller 800 is provided in order to control the operation of rotation drive 625 and of winding drive 623, so as to actuate winding system 630 to wind the incoming element 12 onto spatial loading system, while rotating bobbins 616 in a corresponding direction. Controller 800 is operative to adjust rotation drive 625 in a manner so as to adjust the rate of travel and optionally, other dynamic conditions, such as the tension of element 12 at which it is collected by spatial loading system 500 from the inlet port 602 and conveys it to the outlet port 600 of the enclosure 520.

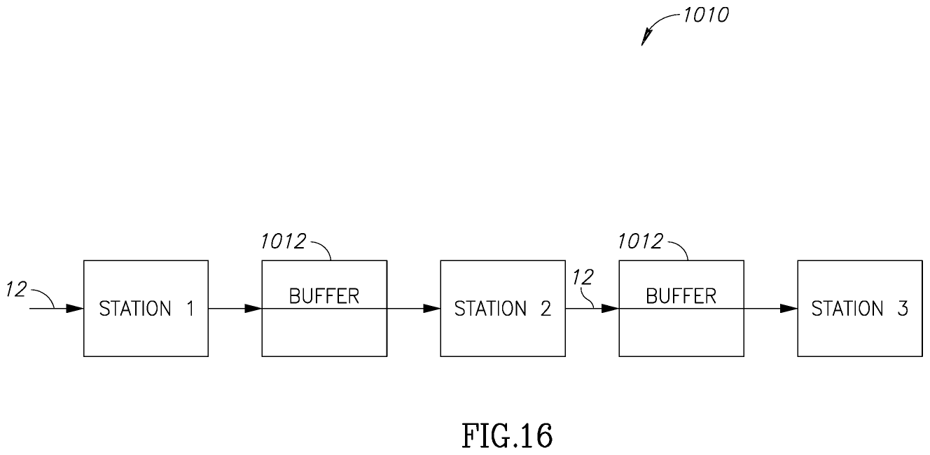

As seen in FIG. 14 and in more detail in FIGS. 15A and 15B, winding system 630 is seen to typically wind elongate element 12 along a loading path 502, illustrated in FIG. 15A in profile, which, as stated, is typically helical. As seen in FIG. 14, treatment unit 516 may be used as a buffer, whose primary use is to balance the speed of travel and optionally tension of element 12, as it is fed from one upstream station to a subsequent downstream station, as described below in conjunction with FIG. 16.

Referring now in more detail to FIGS. 15A-15D, elongate flexible element 12 is wound about loading system 500 and fed out therefrom by a winding pair which includes a leader element 720 and a static follower 771. Static follower 771 is preferably a slotted end portion of winding arm 700, and leader element 720 is mounted onto a guide screw 730 affixed perpendicular to winding arm 700 so as to rotate therewith. Rotation of winding arm 700 is operative to cause a corresponding rotation of both leader element 720 and static follower 771 in fixed mutual angular relationship, while, at the same time, there being a linear translation of leader element 720 towards static follower 771, as described below.

It will be appreciated that while a specific direction of rotation of winding arm 700 is shown and described herein, for the winding accumulation of the element 12 within unit 516, the direction of rotation of winding arm 700 may be reversed, so as to facilitate the unwinding of element 12, and its paying it out in the opposite direction.

The described translation of leader element 720 along guide screw 730 is provided by the positioning of guide chain or belt 710 about gear wheel 705 (FIGS. 15A-15B) which is immovably secured to base 615 by a pair of rods 619 place and a corresponding element 715 (FIG. 15B) on guide screw 730. With gear wheel 705 being fixed in position, rotation of winding arm 700 causes element 715 to rotate thereby causing a corresponding rotation of guide screw 730. Alignment member 735 has a fixed mounting on static follower 771, and extends freely through an opening (not shown) in leader element 720. Accordingly, as guide screw 730 rotates, the resulting effect on leader element 720, which, as mentioned, is threadingly mounted thereon, and is also prevented from relative rotation thereabout by alignment member 735 extending therethrough, is to displace leader element 720 along the guide screw 730.

Static follower 771 of winding arm 700 has a groove formed thereon (FIGS. 15C and 15D) and received receive element 12 from inlet port 602 (not shown), and from there element 12 flows to leader element 720 from where it exits via exit port 600 (not shown) via guide 772. Rotation of winding arm 700, however, is operative to guide the element 12 along a helical winding path, while, as described above, leader element 720 is moved along guide screw 730 so as to wind the element about the bobbins 616 as illustrated in FIGS. 15C and 15D.

It will be appreciated that the coiled accumulation of element 12 on rotational spatial loading system 500 is of a total length that is significantly greater than the distance between the inlet and exits ports 22 and 24 as described above in conjunction with FIG. 5.

Referring once again to FIGS. 13A-13C, in the currently illustrated implementation as a dryer, unit 516 includes temperature treatment apparatus 534, typically a heater, located within enclosure 520, for drying the elongate windable element. It will be appreciated that treatment by the treatment apparatus may cause, as described above, a release of certain process materials that it is desired to contain. Accordingly, so as to substantially seal enclosure 520, and prevent an uncontrolled exhaustion of the interior gaseous atmosphere from enclosure 520 to its exterior, there is provided pressure-reducing apparatus 536, implemented herein as a blower, operative to cause a localized reduction in pressure adjacent to the inlet port 602.

In the present embodiment, as seen, temperature treatment apparatus 534 and blower 536 (FIGS. 12B-13B) are positioned on a wall 610 of enclosure 520, to the rear of a partition 614. Air or other ambient gas within enclosure 520 is heated by heater 534 circulated by blower 536, through an opening 612 provided in partition 614 (seen also in FIG. 12B), and thereafter about rotational spatial loading system 500 in the direction indicated by arrows 651 in FIG. 13A.

In certain embodiments, controller 800 can be operable by at least one processor configured to execute software. In certain embodiments, controller 800 can be operably by a plurality of electric switches operable according to an embedded software in controller 800. Treatment unit 516 can include a sensor 590 arranged within enclosure 520 to collect measurements, for example, temperature, humidity, presence of a predetermined gas and/or the like. Sensor 590 is operative to communicate with controller 800 to facilitate the operation of treatment unit 516 by controller 800. For example, controller can operate blower 536 to increase or decrease the amount of hot air blown into gaseous environment according to a temperature measurement of the sensor 590 to ensure optimal temperature in the enclosure 520 for treatment of the element 12. Controller 800 can provide the information to an output (not shown), such as a display, thereby facilitating an operator of treatment unit 516 to track the conditions of the gaseous environment. Based on the information, the at least one processor or the operator, via controller 800, can operate treatment unit 516 to provide the desired treatment to the elongate windable element.

Reference is now made to FIG. 16, illustrating a multi-station system 1010, generally similar to system 10, shown and described above in conjunction with FIG. 1. However, element 12 may egress each station at certain dynamic conditions, such as rate of travel and tension, which may not necessarily be equal to the desired rate of travel and tension as for ingress into the subsequent, downstream station.

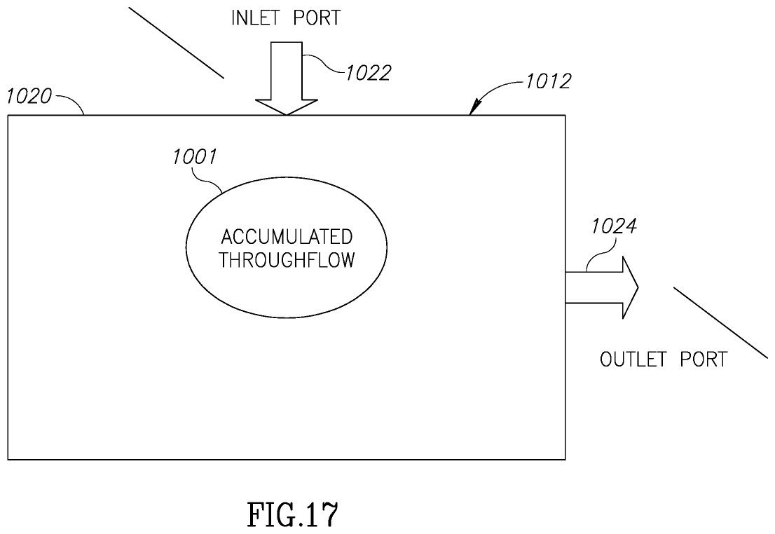

In order to compensate for these potential differences, there are provided one or more buffer units 1012, for the purpose of optimizing processing of through flowing element 12. Buffer units 1012, illustrated schematically in FIG. 17, include an enclosure 1020, inlet and outlet ports 1022 and 1024, respectively, and a spatial loading system 1001, such as system 400 or 500 as shown and described above in conjunction with FIGS. 3A-15D. It also envisaged that this function may be provided by one or more of the treatment units 416 or 516 shown described above, in a multi-station system.

It will thus be appreciated that when sought to change the dynamic conditions, such as, rate of travel and/or tension of the through flowing element 12, a given buffer unit 1012, receiving element 12 at a first rate of travel and/or tension, may be operated to selectively accumulate and pay out element 12 at a second rate of travel and/or tension, different from the first rate of travel and/or tension, but equal to the rate of travel and/or tension suitable for the intake of the downstream station.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-48. (canceled)

49. A treatment unit for treating a continuously through-flowing elongate windable element, wherein said unit includes:
(a) a substantially sealed enclosure for containing a gaseous environment, said enclosure having an inlet port for the continuous ingress of an elongate windable element and an outlet port for the continuous egress of treated elongate windable element;
(b) treatment apparatus located within said enclosure, for treating the elongate windable element therein; and
(c) a spatial loading system located within said enclosure, for continuous collection of the elongate windable element within said enclosure, and for conveying the elongate windable element from said inlet port to said outlet port.

50. A treatment unit according to claim 49, wherein treatment by said treatment apparatus causes a release of materials sought to be contained into the interior of said enclosure, and said treatment unit also includes pressure-reducing apparatus within said enclosure for preventing the exhaustion of the materials sought to be contained from within said enclosure to the exterior thereof.

51. A treatment unit according to claim 49, and wherein said spatial loading system is operative to convey the elongate windable element through said enclosure at a rate predetermined so as to expose it to treatment by said treatment apparatus for a predetermined dwell time.

52. A treatment unit according to claim 49, wherein said inlet and outlet ports are spaced apart by a predetermined linear distance, said spatial loading system includes at least one loading member having a non-linear loading surface for winding the elongate windable element therealong along a non-linear loading path,
and wherein the length of the loading path is of a magnitude which is at least three times the linear distance between said inlet and outlet ports.

53. A treatment unit according to claim 52, wherein said at least one loading member has a generally cylindrical surface for receiving the elongate windable element in a wound arrangement.

54. A treatment unit according to claim 53, wherein
said non-linear loading path is serpentine;
at least one of said loading members is revolvable; and
said spatial loading system also includes a drive for rotating said at least one revolvable loading member.

55. A treatment unit according to claim 54, wherein said at least one loading member includes a plurality of discrete loading members defining nodes along said serpentine loading path, and wherein said plurality of discrete loading members includes first and second opposing arrangements of discrete loading members, and wherein on loading, the elongate windable element becomes wound alternately about opposing loading members of each of said first and second arrangements, along said serpentine loading path.

56. A treatment unit according to claim 55, wherein:
said inlet port is a slotted opening for the lateral insertion of a length of the elongate winding element into said treatment unit;
said first arrangement of discrete loading members is arranged in a predetermined mutual spatial relationship relative to said slotted opening so as to receive the elongate winding element therefrom;
said second arrangement of discrete loading members is movable relative to said first arrangement and said slotted opening between a first position and a second position,
wherein, in said first position, said second arrangement is disposed such that said slotted opening is disposed between said first and second arrangements,
and in said second position, said second arrangement is disposed distally from said slotted opening such that said first arrangement is positioned therebetween;
wherein each loading member of each said first and second arrangements is spaced apart so as to enable passage of said second arrangement of discrete loading members through said first arrangement of discrete loading members when moving between said first and second positions; and
wherein when said second arrangement is located in said first position and a length of the elongate windable element is introduced laterally through said slotted opening so as to overlie said first arrangement of discrete loading members, said second arrangement is operative to translate towards said second position, through said first arrangement of discrete loading members, towards said second position, so as to engage the elongate windable element and to pull it through said members of said first arrangement along said serpentine loading path.

57. A treatment unit according to claim 54, wherein
wherein said loading path is helical; and
said spatial loading system also includes a rotational winding arm for engaging the elongate windable element so as to wind it around said at least one loading member; and said at least one loading member is configured to receive the elongate windable element thereabout in a helical arrangement; and
wherein said spatial loading system also includes:
a drive;
a transmission for transmitting a rotational motion from said drive to said rotational winding arm; and
a controller for controlling the operation of said drive, said controller operative to adjust said drive in a manner so as to adjust the dynamic conditions at which said spatial loading system collects and conveys the elongate windable element from said inlet port to said outlet port of said enclosure.

58. A treatment unit according to claim 57, wherein at least one of said loading members is revolvable, and wherein said transmission is also operative to transmit a second rotational motion from said drive to said at least one revolvable loading member.

59. A treatment unit according to claim 57, wherein said at least one revolvable loading member includes a plurality of generally cylindrical loading members mounted within said enclosure onto a central support axis defining said central axis, and wherein said at least one revolvable loading member is adapted for selectable rotation about said central axis.

60. A treatment unit according to claim 49, wherein said treatment apparatus includes at least two mutually independently operable treatment sources for treating the elongate flexible element in at least two mutually independent treatment zones.

61. A treatment unit according to claim 49, wherein the elongate flexible element is marked with a marking substance and after entry into said enclosure through said inlet port, said spatial loading system is operative to expose the substance bearing elongate flexible element to a predetermined treatment by said treatment apparatus for a desired dwell time.

62. A treatment unit according to claim 61, wherein the elongate flexible element is a dyed thread, said treatment unit is a dryer, and said treatment apparatus includes at least one heat source operative to dry the thread prior to its egress from said dryer.

63. A collection unit for handling of a continuous through flow of an elongate windable element, said collection unit including:
(a) an enclosure for the through-processing of a continuously through-flowing elongate windable element, said enclosure having an inlet port for the continuous ingress of the elongate windable element and an outlet port for the continuous egress of the elongate windable element; and
(b) a spatial loading system located within said enclosure, for continuous collection and paying out of the elongate windable element within said enclosure, and for conveying the elongate windable element from said inlet port to said outlet port.

64. A collection unit according to claim 63, wherein said spatial loading system is mounted within said enclosure onto a central support axis defining a central axis, said spatial loading system being mounted for selectable rotation thereabout.

65. A multi-station system of processing a continuous throughflow of an elongate windable element, which includes:
(a) at least first and second treatment units constructed and operative according to claim 49 for the through flow and treatment of an elongate windable element, said second treatment unit being operable to normally receive from said first treatment unit an outflow of elongate windable element treated therein in a continuous process,
wherein said first treatment unit is operative to emit therefrom the elongate windable element at a first rate of travel, and said second treatment unit is operative to intake the elongate windable element at a second rate of travel, and
wherein said first and second rates are different one from the other; and
(b) at least one collection unit disposed between said at least first and second units, adapted for selectably receiving and collecting a throughflow of the elongate windable element from said first treatment unit at said first rate, and for providing the elongate windable element to said second treatment unit at said second rate, wherein said at least one collection unit is operative to selectively collect the through flowing element at a rate selected to change the rate of travel of the through flowing element from said first rate to said second rate.
